(19) United States
(12) Patent Application Publication
(10) Pub. No.: US 2013/0101776 A1
(43) Pub. Date: Apr. 25, 2013

(54) PATTERNED HYBRID ADHESIVE FOR APPLIQUE FILM

(71) Applicants: Jue Lu, Okemos, MI (US); Parviz Soroushian, Okemos, MI (US)

(72) Inventors: Jue Lu, Okemos, MI (US); Parviz Soroushian, Okemos, MI (US)

(73) Assignee: METNA CO, Lansing, MI (US)

(21) Appl. No.: 13/277,387

(22) Filed: Oct. 20, 2011

(51) Int. Cl. B32B 33/00; B32B 37/12; B32B 38/04; C09J 7/02; B32B 38/10

(52) U.S. Cl. 428/41.8; 428/195.1; 156/249

(57) ABSTRACT

This invention relates to appliqué film for paint replacement application on aircraft and other surfaces. This system comprises a carrier backing film with patterned hybrid pressure sensitive adhesives (PSAs), with discrete silicone phase within a continuous acrylic phase. The patterned hybrid PSAs exhibit a peel strength between 2 and 8 pound per in (pli) in the temperature range of −65° F. to 285° F. This appliqué film also provides high levels of stability under exposure to weathering effects and fluids applied to exterior aircraft surfaces.

### STATEMENT REGARDING FEDERALLY SPONSORED RESEARCH OR DEVELOPMENT

Subject matter described herein was developed with the SBIR funding provided by the United States Government under Grants from the Navy (N68936-09-C-0111). The U.S. Government may have certain rights to the invention.

### CROSS-REFERENCE TO RELATED APPLICATIONS

Not applicable.

### BACKGROUND OF THE INVENTION

The following is a tabulation of some prior art that presently appears relevant:

| Pat. No. | Kind Code | Issue Date | Patentee |
|---|---|---|---|
| 6,475,616 | B1 | November 2002 | Dietz et al. |
| 7,544,407 | B1 | June 2009 | Rawlings et al. |
| 5,436,303 | | July 1995 | Shaw |
| 4,889,234 | | December 1989 | Sorensen et al. |
| 6,495,229 | B1 | December 2002 | Carte et al. |
| 5,449,540 | | September 1995 | Calhoun et al. |

### NONPATENT LITERATURE DOCUMENTS

Benedek, I. Pressure-sensitive adhesives and applications. New York, Marcel Dekker, Inc. pp. 80-94 (2004).
Benedek, I. Pressure-Sensitive Design and Formulation, Applications. Boston, Mass., VSP Intl Science, (2006).
Cushman, M., N. Orbey, et al. (2004). High temperature appliqué films for advanced aircraft coatings, Soc. for the Advancement of Material and Process Engineering, Long Beach, Calif., the United States.
Ihbe, T. S. and T. M. Dietz (2003). Recent advances in appliqué film technologies for aerospace coatings, Soc. for the Advancement of Material and Process Engineering, Long Beach, Calif., the United States.

Aircraft surfaces receive paints which protect them against deterioration in aggressive (e.g., corrosive) environments. Paint removal and recoating of aircraft surfaces release volatile organic compounds (VOC) and other hazardous materials to the environment. Major progress has been made towards replacement of paint with appliqué films applied using pressure-sensitive adhesives, which promise significant advantages over traditional paints in terms of environmental impact, ease of application and removal, and life-cycle economy. Appliqué films also promise advantages over paints in terms of performance, reliability and amenability to health monitoring (Cushman, Orbey et al. 2004). It is generally believed that a logical solution to the corrosion problems of aircraft surfaces would result from the application of an appliqué system embodying advanced corrosion inhibition features. Typical requirements for appliqués used on aircraft include: (1) a continuous service temperature from −65° F. to 285° F. for up to 1,000 hours while retaining 2 to 8 pound per linear inch (pli) peel strength (as measured by the 180-degree peel adhesion test method); (2) resistance to fluids which are applied intentionally or accidentally to aircraft surfaces, including jet fuel, hydraulic fluid, aircraft wash fluids, de-icing fluids, lube oil, radar coolant and the like; (3) durability under environmental exposures such as UV radiation, humidity, salt spray, fog, extreme temperatures and the like; and (4) ease of repositioning and removal from aircraft surfaces while minimizing adhesive residue on substrate. Appliqué systems typically include a protective film, a pressure sensitive adhesive (PSA), and optionally a release liner. Pressure sensitive adhesive (PSA) is an important constituent of appliqué films; improvements in the thermal stability, chemical resistance and removability of pressure sensitive adhesives are needed before appliqué films can realize their full potential as aircraft paint-replacement coatings (Ihbe and Dietz 2003).

The PSAs used in appliqué films are generally acrylic pressure sensitive adhesives, which are restricted to temperatures above 0° F., and can not withstand higher temperatures above 240° F. A high-performance PSA for appliqué film from Minnesota Mining and Manufacturing Company, St. Paul, Minn. (disclosed in U.S. Pat. No. 6,475,616 B1) maintains adhesion in a temperature range of −65° F. to 230° F., and provides good resistance to aircraft fluids, but it dramatically loses the adhesion at temperatures above 230° F. U.S. Pat. No. 7,544,407 B1 developed a more thermally stable adhesive by reacting a non-crosslinked acrylic adhesive with polyisocyanate crosslinker. This PSA exhibited peel strengths within 2 to 8 pli at temperatures between 180-250° F., but working temperatures up to 285° F. have not been realized; in addition, this typical acrylic PSA can not meet the requirement for satisfactory performance at −65° F., as explained in the following.

For acrylic-based pressure sensitive adhesives, the glass transition temperature (T_{g}) ranges from about −40° F. to −13° F. (Benedek 2004). The glass transition temperature is one of the most important parameters determining the lower service temperature of PSAs. Below this temperature, polymers tend to be glassy and brittle with a high modulus, offering low adhesion capacity; above this temperature, the polymer exhibits a rubber-like behavior similar to an elastic fluid. From a molecular point of view, it is possible to design acrylic-based PSAs to meet the requirement for operation at −65° F.; this particular adhesive design, however, may not perform satisfactorily at elevated temperatures. Crosslinking is the most common approach to improve the high-temperature stability of PSAs, which increases the glass transition temperature; other (somewhat less effective) methods, such as addition of a compatible filler, will improve thermal stability with smaller effects on T_{g}. Alternatively, an acrylic-based PSA designed for satisfactory high-temperature performance is unlikely to perform well at the lower temperature of −65° F.

The other major class of PSA is silicone-based. The glass transition temperature of silicone-based PSAs ranges from −184 to −148° F. The peel resistance of both acrylic and silicone PSAs increases with decreasing temperature, but most acrylics PSAs experience a sharp drop in peel resistance at temperatures below −4° F.; the peel resistance of silicone PSAs, on the other hand, continues to increase at lower temperatures, reaching a plateau at temperatures ranging from −58° F. and −99.4° F. (Benedek 2006). Silicone PSAs can meet certain industrial needs for high-performance applications, including resistance to harsh chemical and environmental effects, and stability at extreme temperatures. Silicone PSAs are resistant to moisture, UV light, ozone, weathering, corona discharge, radiation, and most chemicals. When compared with acrylic PSAs, silicone PSAs fall short in terms of aggressive bonding, but they provide relatively strong adhesion over a broad range of temperature (mostly −100° F. to 482° F.). Silicone PSAs also fall short of acrylic PSAs in terms of fuel resistance; silicone PSAs experience significant loss of peel and tack qualities under exposure to some fuels and also organic solvents such as toluene. U.S. Pat. No. 5,436,303 teaches the art of fluorosilicone pressure sensitive adhesives for improved fuel resistance, but two decades of research on this topic has not yet led to development of a commercial product.

It is an object of the present invention to manufacture a patterned hybrid adhesive appliqué film to meet the requirements relevant to aircraft exterior applications in the temperature range of −65 to 285° F. Patterning of adhesive is known in the art to meet application needs. For example, U.S. Pat. No. 4,889,234 disclosed a patterned adhesive label structure having discrete areas with differently patterned adhesive coverages to permit a resealable mode of operation. U.S. Pat. No. 6,495,229 B1 disclosed pattern coated adhesive bandages that strongly adhere to human skin while permitting water vapor transmission there through. U.S. Pat. No. 5,449,540 disclosed a method of making patterned pressure sensitive adhesive transfer tape using a carrier web with recesses or pockets. None of the above cited prior art discloses the application of two distinguishable adhesives in a patterned design and the method of making such object for appliqué application.

### SUMMARY

The following embodiments and aspects thereof are described and illustrated in conjunction with products and methods which are meant to be exemplary and illustrative, not limiting in scope.

The present invention provides for a patterned adhesive appliqué film that meets the requirements relevant to aircraft exterior application at competitive cost. It preserve a peel strength of 2-8 pli in the temperature range of −65° F. to 285° F., and has good resistance to aircrafts fluids, including jet fuels, and environmental exposure. The invention combines the advantages of silicone- and acrylic-based PSAs to meet the demanding requirements relevant to applications on aircraft exterior surfaces. The silicone-based constituent of hybrid PSA contributes low- and high-temperature stability as well as chemical resistance; the acrylic-based constituent provides aggressive room-temperature and high-temperature bonding at relatively low cost, complemented with desired fuel resistance. The unique design of patterned structure comprises a discrete silicone phase surrounded by a continuous thermally stable acrylic phase. This patterned structure can effectively overcome the poor fuel resistance of silicone adhesives due to the protection provided by the fuel-resistant (continuous) acrylic phase against attack on the dispersed silicone phase. The invention also relates to a manufacturing process for making such patterned structure with two adhesives.

### BRIEF DESCRIPTION OF THE DRAWINGS

FIG. 1 is a cross-sectional view of the appliqué film.

FIG. 2 is a top view of the appliqué film, comprising the backing layer and the patterned PSA. The continuous phase in adhesive is acrylic-based PSA, and the discrete phase is silicone-based PSA.

FIG. 3 is a flowchart of a typical method of manufacturing a patterned adhesive for appliqué film.

FIG. 4 is a detailed view of the intermediate product resulting from step 34 in FIG. 3.

FIG. 5 presents peel resistance test results at different temperatures for patterned (hybrid) adhesive PSA appliqué film at different contents of the silicone-based constituent of adhesive.

FIG. 6 presents peel resistance test results for patterned (hybrid) PSA at different temperatures and after exposure to various aggressive (aircraft) fluids.

### DETAILED DESCRIPTION

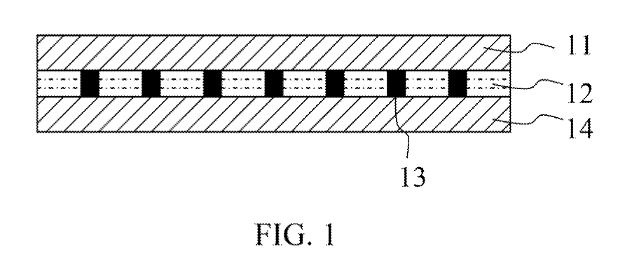

FIG. 1 shows an example appliqué film with patterned hybrid PSAs suiting application to exterior aircraft surfaces. With a combination of acrylic PSA and silicone PSA in a patterned design, this appliqué film can provide a peel strength exceeding 2 pli in a temperature range of −65° F. to 285° F., and can resist many aircraft fluids as well as long-term exposure to weathering effects. As a non-limiting example, the example appliquéfilm shown in FIG. 1 includes a release liner 11, a layer of patterned acrylic (12)/silicone (13) hybrid pressure sensitive adhesive, and a backing film (14). Details of the appliquéfilm and a method of making the patterned structure are set forth below.

The backing film (14) in FIG. 1 may be any suitable polymeric film with good resistance to relevant (e.g., aircraft) exposure conditions. Examples of backing films suiting application to exterior aircraft surfaces are fluoropolymer film and polyimide film (Kapton® available from Dupont). The fluoropolymer film needs to be pretreated for improved adhesion (to adhesives), such as oxygen plasma surface etching, organometallic surface treatments using sodium-naphthalene or sodium-ammonia, corona treatment, flame treatment, and application of a compatible polymer primer solution.

The release liner may be any liner used with silicone pressure sensitive adhesives, most commonly fluorosilicone-based release liners.

The patterned adhesives can be any combination of adhesives with complementary performance attributes. For example, one may provide desired peel resistance at high temperatures, with the other providing desired peel resistance at low temperatures; this requirement is met by a combination of acrylic- and silicone-based pressure sensitive adhesives. A typical thickness of the patterned hybrid adhesive is in the range of 2-5 mils, with a preference for 5 mils.

For application to exterior aircraft surfaces, the acrylic-based constituent of the patterned hybrid PSA should preferably exhibit resistance to aircraft solvents, jet fuel, lube oil, water and the like, and should preferably exhibit high thermal stability, offering a peel resistance of more than 2 pli at temperatures as high as 285° F. The acrylic-based PSA in patterned (hybrid) system can be any of a number of commercially-available acrylic-based pressure sensitive adhesives. A non-limiting example of such acrylic-based PSAs is the 3M™ “ultra high temperature” class of acrylic-based pressure sensitive adhesives.

For application to exterior aircraft surfaces, the silicone-based constituent of the patterned (hybrid) pressure sensitive adhesive should preferably exhibit a minimum peel resistance of approximately 6 pli at −65° F., and desired thermal stability at elevated temperatures. The silicone-based constituent of the hybrid PSA can be any of a number of commercially available silicone-based pressure sensitive adhesives. Non-limiting examples of silicon-based PSAs suiting this application include SCLS PSA 400 and PSA 401 available from Bluestar Silicones.

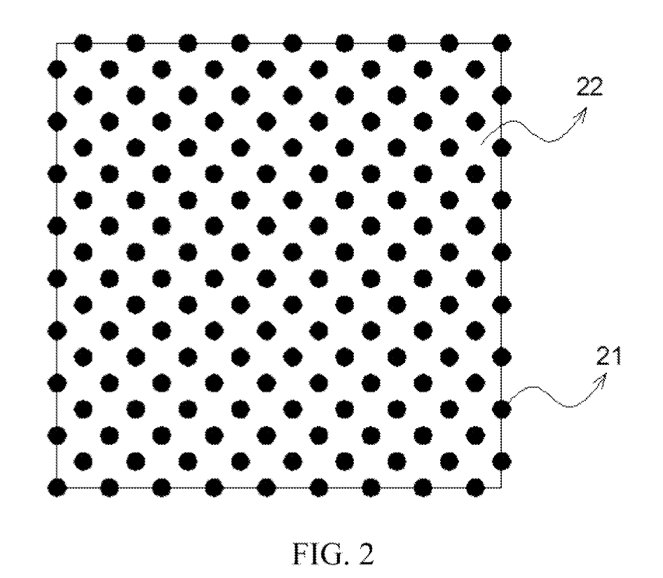

The two PSA constituents of the present invention form a pattern on the backing layer. Any number of patterns may be used to form the patterned (hybrid) PSA. In a preferred embodiment, the acrylic-based PSA forms a continuous network while the silicone-based PSA occurs in discrete (dispersed or disconnected) regions. In this embodiment, the lower fuel resistance of silicone (when compared with acrylic) is overcome due to the protection provided by the fuel-resistant (continuous) acrylic phase against attack on the dispersed silicone phase. The regions covered by the silicone-based PSA can be circular, hexagonal, square or of any other geometric shape. These regions can form rows in the patterned configuration; offsetting the regions in adjacent rows tends to increase the peel at reduced temperatures even with a relatively low content of the silicon-based PSA constituent. A preferred pattern shown in FIG. 2 has the dispersed silicone-based regions occurring at corners of diamonds. An example patterned hybrid PSA comprises a dispersed silicone-based PSA (FIG. 2, 21) covering 10 to 40% of area, with the remainder (most) of the area covered with the acrylic-based PSA (FIG. 2, 22). The prevalence of the continuous acrylic-based PSA benefits the fuel resistance of the patterned hybrid PSA (for application to aircraft exterior surfaces) as well as the cost of the hybrid system (considering the relatively low cost of acrylic-based PSAs when compared with silicon-based PSAs).

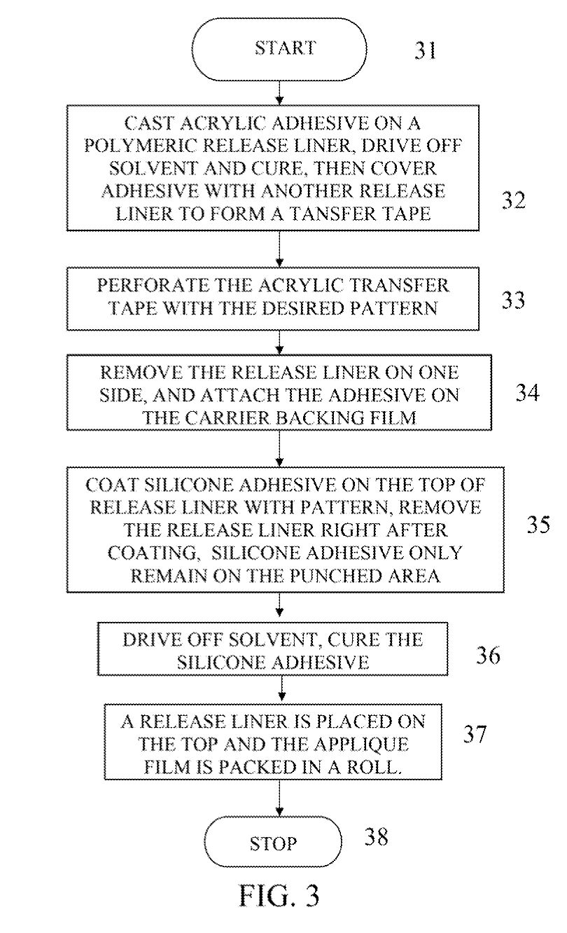

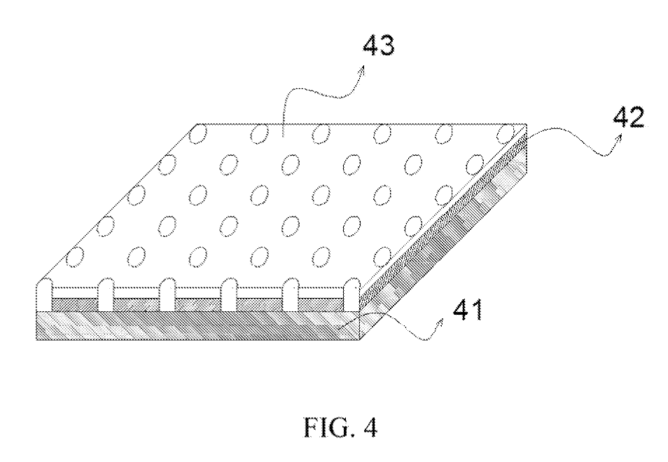

A method of making the appliqué article with patterned hybrid pressure sensitive adhesive will be now described. Referring to FIG. 3, Block 31 is the start point of this example method. Block 32 addresses application of a solvent-based acrylic PSA by coating on a polymeric release liner. Suitable techniques for application of the adhesive include gravure coating or knife-over-the-web coating. Another release liner is used to cover the adhesive and form a transfer tape. Block 33 addresses perforation of the acrylic transfer tape with the desired pattern of the dispersed silicone phase, using any practical means. Block 34 addresses removal of the release liner on one side of the perforated acrylic adhesive, with the other side of perforated adhesive still covered with a release liner attached to the carrier backing film. In more detail, refer to FIG. 4, this intermediate product comprises a backing film (41), an acrylic adhesive layer with free (dispersed) areas (42) covered with a release liner (with free areas too) ready for silicone adhesive coating. Block 35 addresses coating of the solvent-based silicone adhesive on the assembled structure described in FIG. 4. Any means of coating continuous adhesives can be used to implement this step. The release liner (FIG. 4, 41) must be removed immediately after coating and before the solvent in the silicone adhesive is fully driven off. Therefore, silicone adhesive only remains on the patterned area. The solvent is then completely driven off, and the adhesive maybe cured (Block 36). Block 37 addresses placement of a release liner, preferably fluorosilicone-based, on the patterned hybrid adhesive, followed by packing of the appliqué film into a roll.

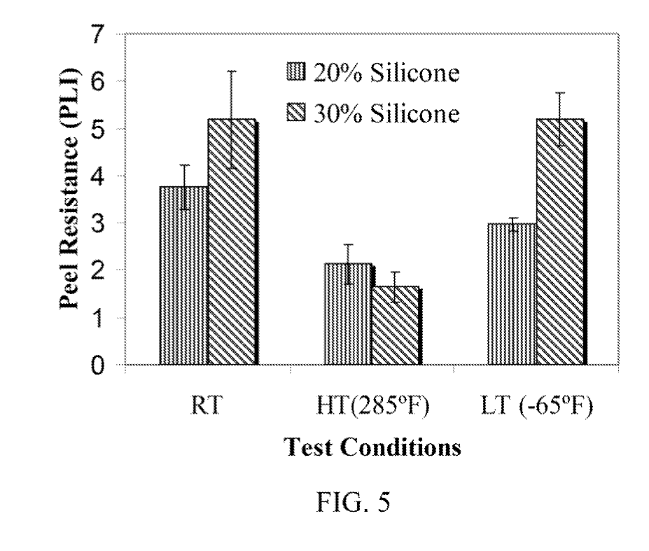

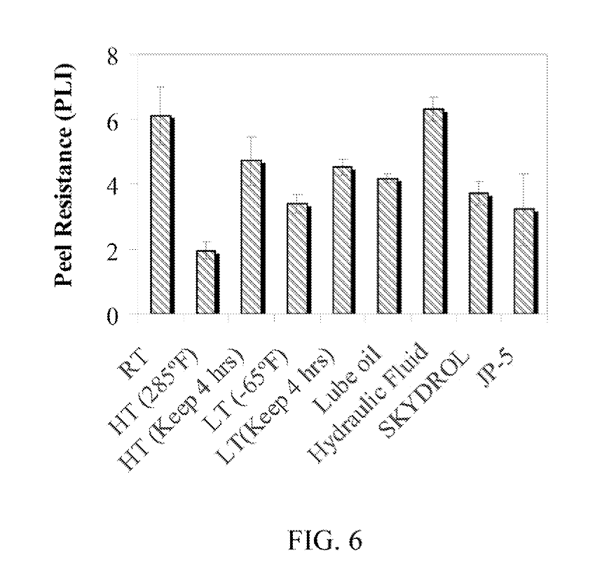

In reference to FIG. 5, the peel resistances of two patterned hybrid adhesive systems (180° peel test per PSTC-1) at temperatures of −65, 75 and 285° F. are compared. These two hybrid system comprise acrylic- and silicone-based constituents at different proportions, which are patterned as shown in FIG. 2. The test results presented in FIG. 5 indicate that with increasing the area covered by the dispersed silicone adhesive, peel resistance increases at low temperature and room temperature, but decreases at high temperature. One can thus produce patterned hybrid pressure sensitive adhesives with tailored proportions of its constituents to meet the thermal stability requirements relevant to different applications. In FIG. 6, the peel resistance of the appliqué film with hybrid PSA having 20% silicone-based constituent remained within the range of 2 to 8 pli in temperatures ranging from −65° F. to 285° F. This patterned hybrid PSA was also found to be resistant to various aircraft fluids. The details of appliqué test coupon preparation and experimentation are presented in the following.

Appliqué test coupon preparation: Test coupons were prepared in the following manner. Aluminum 2024QQ-A-250/4-T3 sheets with 0.071″ thickness were cut into 3″ by 3″ test coupons, and were thoroughly cleaned using alkaline cleaner with scotch brite (per Mil 87937). Test coupons were chem.-filmed according to the application spec Mil-C-5541, and air-dried. Test coupons were then primed with water-reducible, low-density epoxy primer MIL-PRF-8552d TY-11 CLASS-C2 to a dry thickness of 0.8-3 mil. The primer was then cured at room temperature for at least 10 hours. Before applying the appliquéfilm, test coupons were scuffed and sand-primed with the sandpaper grit 220 or finer to remove the gloss, and then cleaned using a cheese cloth moistened with isopropyl alcohol, and then using a clean, dry cheese cloth. Appliqué film strips (1″×3″) were then applied on the test coupon, and peel tests were performed after 20 minutes.

Peel adhesion strength: All tests were performed per PSTC-1 ((Pressure Sensitive Tape Council) Peel Adhesion of Single Coated Pressure Sensitive Tapes at 180° Angle). At least 3 samples were tested at each temperature or condition considered, and the average peel resistance was obtained. Coupons having appliqué test strips were evaluated at room temperature, and also at −65° F. and 285° F. Peel tests were initiated 5 minutes after stabilizing the sample at the targeted temperature. The force required to initiate peeling at 180° angle was recorded, and peel resistance was calculated as force per unit width (pound per linear inch—pli).

Thermal stability test: The test coupons having appliqué test strips were kept at −65° F. or 285° F. for four hours. The test coupons were then stabilized at room temperature overnight, and 180° peel resistances tests were conducted as described above.

Aircraft fluid resistance: This test was used to evaluate the resistance of the appliqué which is subject of this invention to various aircraft fluids. Test coupons were totally immersed in test fluids at specific temperatures and for certain time periods, as described below. The test coupons were subsequently removed from the fluids, wiped dry, and then stabilized at room temperature for 24 hours before performance of peel tests following the procedures explained above.
JP-5: 75° F. for 30 days.
Lube oil: 250° F. for 24 hours.
Hydraulic fluid: 150° F. for 24 hours.
Skydrol: 75° F. for 30 days.

What is claimed is:

1. An appliqué film comprising a carrier backing film, and a hybrid pressure-sensitive adhesive layer in a patterned configuration, wherein said hybrid pressure-sensitive adhesive layer comprises a continuous acrylic phase and a discrete silicone phase dispersed within the acrylic phase in said the patterned configuration, with each discrete area covered by the silicone phase assuming at least one of circular, elliptical, square, rectangular and polygonal shapes, and the plurality of discrete silicone areas forming said patterned configuration comprising rows which are offset with respect to adjacent rows, with said dispersed silicone-based phase covering 10 to 40% of the adhesive area, and said hybrid pressure-sensitive adhesive providing 2 to 8 pounds per linear inch 180-degree peel resistance over a temperature range of −65 to 285 degrees Fahrenheit.

2. The appliqué film as set forth in claim 1, wherein said patterned configuration of said hybrid pressure-sensitive adhesive comprises discrete areas covered by said silicone phase which occur at corners of diamond shapes.

3. The appliqué film as set forth in claim 1, wherein said acrylic phase of said hybrid pressure-sensitive adhesive retains 2 to 8 pounds per linear inch 180-degree peel resistance over a temperature range of room temperature to 285 degrees Fahrenheit after resistance to aircraft fluids, salt spray and weathering effects.

4. The appliqué film as set forth in claim 1, wherein said silicone phase of said hybrid pressure-sensitive adhesive provides 180-degree peel resistance of at least 6 pounds per linear inch at temperatures below room temperature down to −65 degrees Fahrenheit, and a peel resistance of at least 1 pound per linear inch at temperatures above room temperature up to 285 degrees Fahrenheit.

5. The appliqué film as set forth in claim 1, wherein said carrier backing film comprises a polymeric film with or without pretreatment, with said polymeric film made of at least one of polyurethane, nylon, fluoropolymer and polyimide, and said the pretreatment of said polymeric film involving at least one of oxygen plasma surface etching, organometallic surface treatments using sodium-naphthalene or sodium-ammonia, corona treatment, flame treatment, and application of a compatible polymer primer solution.

6. The appliqué film as set forth in claim 1, further comprising a release liner applied on the free surface of said hybrid pressure-sensitive adhesive, wherein said release liner is a film comprising at least one of polyester, polyethylene, polypropylene and polymethyl methacrylate film covered with fluorosilicone release coating.

7. A method of making an appliqué film with patterned adhesive layer of claim 1, comprising the following steps:
a) forming an assembly comprising an acrylic pressure-sensitive adhesive sandwiched between two release liners;
b) punching of said assembly to form holes of at least one of circular, elliptical, square, rectangular and polygonal shapes occurring in rows which are offset with respect to adjacent rows;
c) removal of one of said release liners, and its replacement with a carrier backing film attached to the remainder of said assembly;
d) casting of silicone pressure-sensitive adhesive on top of the remaining release liner in said assembly, and removal the release liner right after casting to form discrete areas of silicone pressure-sensitive adhesive on discrete patterned areas formed by said punched holes;
e) driving off any solvents, and curing the silicone pressure-sensitive adhesive; and
f) application of a release liner on the exposed face of the patterned pressure-sensitive adhesive, and packing the end product.

8. The method of making an appliqué film as set forth in claim 7, wherein said release liner comprising a polymeric film made of at least one of polyester, polyethylene, polypropylene, and polymethyl methacrylate.

9. The method of making an appliqué film as set forth in claim 7, wherein removal of release liner in step d is carried out immediately after casting of said silicone pressure-sensitive adhesive and prior to full removal of any solvents in said silicone pressure-sensitive adhesive.
